(19) United States
(12) Patent Application Publication
(10) Pub. No.: US 2011/0025260 A1
(43) Pub. Date: Feb. 3, 2011

(54) CHARGER FOR VEHICLE USE

(75) Inventors: Chi Chun LI, Taipei County (TW); Yung HAN, Taipei County (TW)

Correspondence Address: RABIN & Berdo, PC, 1101 14TH STREET, NW, SUITE 500, WASHINGTON, DC, 20005, US

(73) Assignee: HERO BEAR ANIMATION CO., LTD., Taipei County (TW)

(21) Appl. No.: 12/845,021

(22) Filed: Jul. 28, 2010

(30) Foreign Application Priority Data
Aug. 3, 2009 (TW) 098214317

(51) Int. Cl. H02J 7/00

(52) U.S. Cl. 320/107

(57) ABSTRACT

This invention relates to an improved charger for vehicle use including an plug of cigarette lighter; a first power cord with one end electrically connected to the plug of cigarette lighter; a transformer that is electrically connected to another end of the first power cord; a second power cord with one end connected to the transformer and has an insertion terminal at another end; and a connection unit with insertion hole at one end to be electrically connected to the insertion terminal of the second power cord, and another end of the connection unit is configured with an insertion part which can easily and conveniently work with various prior-specified power adapter of portable electronic devices.

### FIELD OF THE INVENTION

This invention specifically relates to an improved charger for vehicle use that can provide the function of easy charging inside a vehicle via an improved charger for almost all kinds of portable electronic devices, etc.

### DESCRIPTION OF PRIOR ART

A portable electronic device, for instance: a notebook computer, is usually provided with a power adapter that can be connected to indoor power socket for charging. However, the original adapter can only be used for indoor power charging and it could not be used for the same purpose through the power inside a vehicle. Therefore, some spare batteries might be necessary for outdoor power supply. Besides, the general user can is purchase an additional charger for using inside the vehicle as provided by the electronic device supplier. On the other hand, it is quite possible that different electronic devices work with different voltage level, and different electronic devices might be designed with different insertion specification for input of an external power source. Under such a situation, it will not be strange for a general user to own as many chargers individually fit for those different kinds of electronic devices.

Therefore, some concerned suppliers developed a prior charger for vehicle use 9 (as shown in FIG. 5) which includes a plug of cigarette lighter 91, a transformer 92 that is electrically connected to the plug of cigarette lighter 91 via a power cord, an electrical fan 93 installed at the rear end of the transformer 92, and at least two sockets 94 installed at the front end of the transformer 92.

Although the above mentioned charging device can be applied inside a vehicle for charging the portable electronic device, the transformer 92 not only has more complicated internal circuit design, but also needs a radiator fan for removing heat generated during operation. It inevitably leads to a drawback of large volume and heavy weight of the transformer 92. That is, the prior charging device could not provide an easy and convenient solution for charging those portable electronic devices inside a moving vehicle.

### SUMMARY OF THE INVENTION

Therefore, the main objective of this invention is to provide an improved charger for vehicle use, which is characterized with a simple structure, easy for carrying and, above all, is suitable for power charging of all kinds of general specified portable electronic devices, etc. inside a vehicle without at the expenses of large and heavy adapters.

To achieve the above objective, this present invention is including: a plug of cigarette lighter; a first power cord with one end electrically connected to the plug of cigarette lighter; a transformer electrically connected to another end of the first power cord; a second power cord with one end electrically connected to the power output end of transformer, and another end of the second power cord is configured with an insertion terminal; and a connection unit with insertion hole that can be electrically connected to the insertion terminal of the second power cord, and another end of the connection unit is configured with an insertion part. The insertion part can be directly connected with the common-used and standard-specified adapters to convey the car power to the portable electronic device. Alternatively, the insertion part of the present invention is adopted according to the specification of that original adapters to accept external power (the range of input AC voltages are from 100 to 240 volts), and is usually configured as a type of two holes or three holes female socket, or a parallel socket, etc. to act as a bridge to transmit the power from the vehicle to the electronic device.

To achieve the above objective, the above-mentioned second power cord can be directly simplified to configure its insertion terminal with the output end of the transformer. Besides, the plug of cigarette lighter of this invention can be equipped with a wire winder at the rear part to reel in or out the first power cord. Hence, during the operation, through the functioning of this wire winder, the first power cord can be extended to a proper length; or even after use, the wire winder can be reeled in to have an easy and convenient collection, and to provide a minimized portable charger structure to meet the purpose of this invention.

### BRIEF DESCRIPTION OF THE DRAWINGS

FIG. 1 illustrates a three-dimensional appearance of the first embodiment of the present invention.

FIG. 2 illustrates the practical application of the first embodiment of the present invention.

FIG. 3 illustrates the second embodiment of the present invention.

FIG. 4 illustrates the third embodiment of the present invention.

FIG. 5 illustrates a three-dimensional appearance of the prior charging structure.

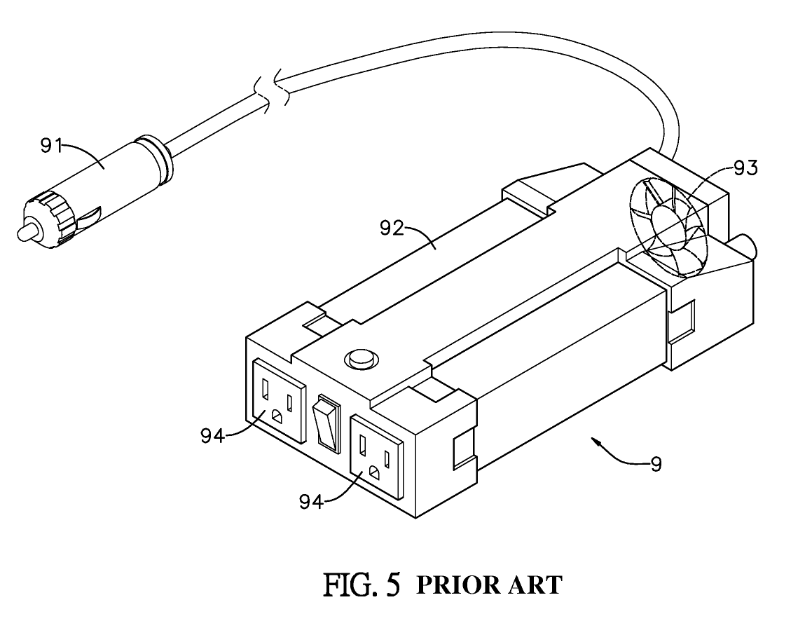

### DESCRIPTIONS OF THE SYMBOLS OF THE MAJOR COMPONENTS

### Components in the Prior Art

| | |
|---|---|
| 9 | Prior charger for vehicle use |
| 91 | Plug of cigarette lighter |
| 92 | Transformer |
| 93 | Fan |
| 94 | Socket |

(Components in this Invention)

| | |
|---|---|
| 1 | Plug of cigarette lighter |
| 1a | Plug of cigarette lighter |
| 2 | First power cord |
| 3 | Transformer |
| 4 | Second power cord |
| 5 | Connection unit |
| 6 | Output power socket |
| 7 | Portable electronic equipment |
| 8 | Wire winder |
| 41 | Insertion terminal |
| 51 | Insertion hole |
| 52, 53 | Insertion part |
| 71 | Transformer |
| 72 | Insertion socket |

### DETAILED DESCRIPTION OF THE INVENTION

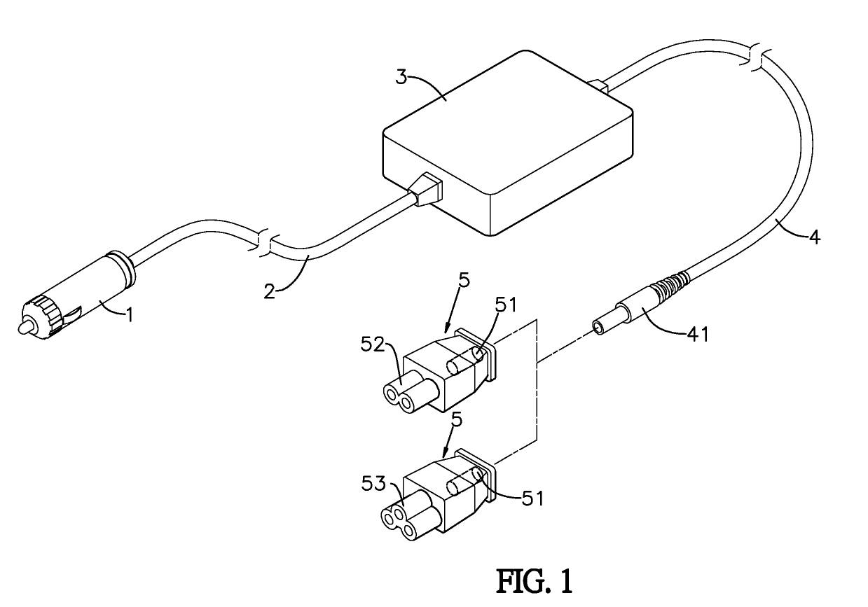

Please refer to the “FIG. 1”, it shows a three-dimensional appearance of the first embodiment of the present invention, an improved charger for vehicle use, which is primarily including: an plug of cigarette lighter 1, a first power cord 2, a transformer 3, a second power cord 4 and a connection unit 5.

The plug of cigarette lighter 1 can generally be connected to and work with an external DC power from 10 volts to 30 volts.

One end of the first power cord 2 is electrically connected to the plug of cigarette lighter 1.

The transformer 3 is electrically connected to another end of the first power cord 2.

One end of the second power cord 4 is electrically connected to transformer 3, and another end of the second power cord 4 is configured with an insertion terminal 41.

The connection unit 5 is, at one end, configured with an insertion hole 51 that is electrically connected to another end of insertion terminal 41 of the second power cord 4. The insertion parts 52, 53, formed at the other end of the connection unit 5, can be actively joined with the adapter of the traditionally used portable electronic equipment that complies with the unified specifications, and each insertion part 52, 53 can be configured as a type of two holes or three holes female socket, or a parallel socket, etc. to act as a bridge to transmit the power from the vehicle to the electronic device, therefore, to form the general appearance and structure of the present invention.

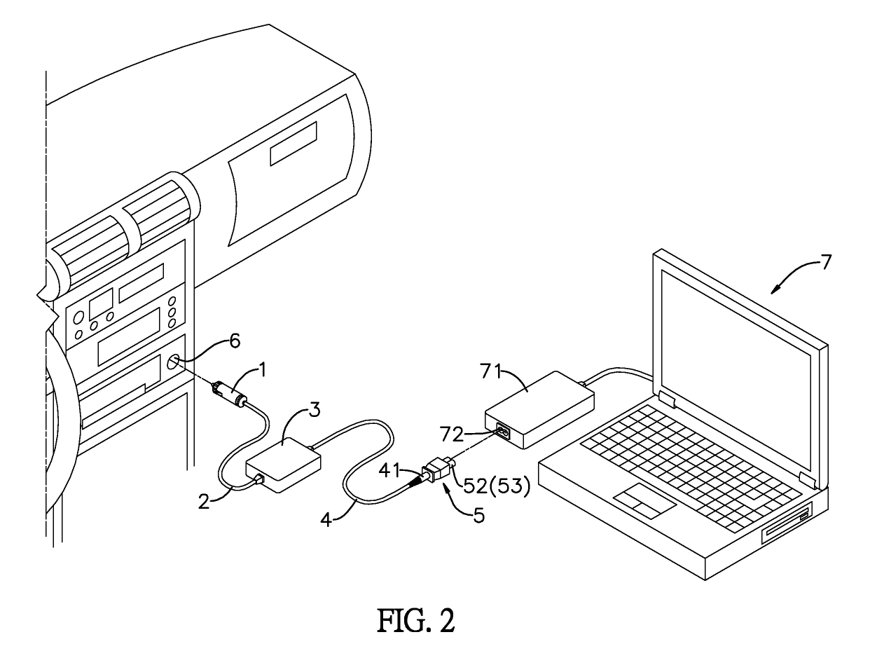

Please refer to the “FIG. 2”, which illustrates the practical application of the first embodiment of the present invention. As shown in this figure (please also referring to FIG. 1 together), the insertion parts 52, 53 (two holes or three holes female socket) are adopted according to the specification of the insertion socket 72 configured at one end of the original transformer 71 connecting with the portable electronic device 7. And, the insertion terminal 41, located at one end of the second power cord 4, is put into the insertion hole 51 of the connection unit 5. After that, the plug of is cigarette lighter 1 of this invention is put into the output power socket 6 inside the vehicle for charging purpose. It starts the power transmission from the plug of cigarette lighter 1 to the transformer 3 via the first power cord 2. Generally, the output DC power ranges from 10 volts to 30 volts. During this process, the transformer operates a function (up-conversion) to increase the DC voltage up to a range from DC 300 volts to 350 volts. And, the increased DC voltage is output via the second power cord 4 and the connection unit 5 in series and is transmitted into the insertion socket 72 of the original transformer 71 connecting with the portable electronic device 7. The prior-specified transformer can automatically transform the power and feed it into the portable electronic device 7 for charging and/or operation.

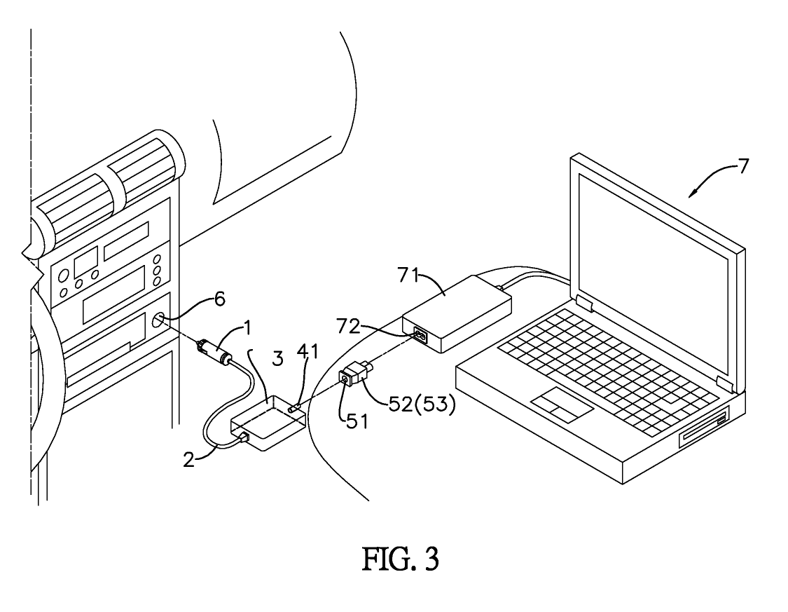

Please refer to the “FIG. 3”, which illustrates the second embodiment of the present invention. As shown in this figure, a insertion terminal 41 located at the front end of the above mentioned second power cord 2 is installed directly to the output end of the transformer 3 so as to simplify the second power cord 4 and reduce the manufacturing cost of the current invention. It provides a better collection and a more convenient portability of this invention.

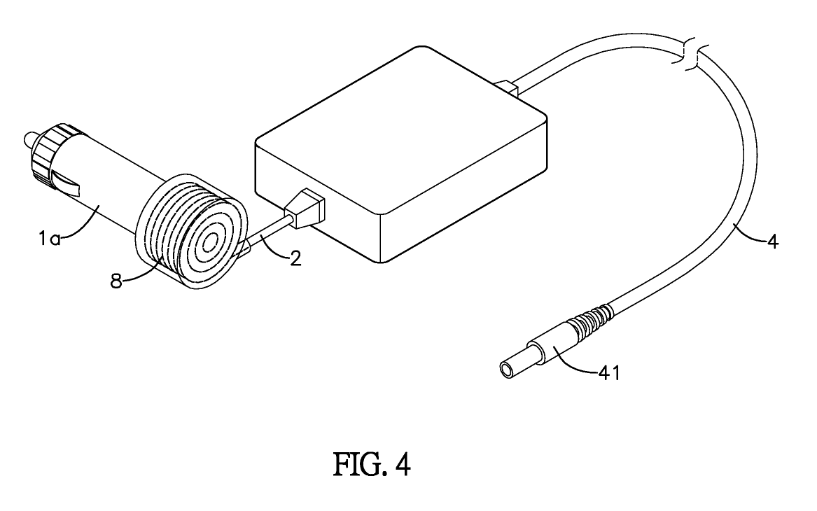

Please refer to the “FIG. 4”, which illustrates the third embodiment of the present invention. As shown in this figure, the plug of cigarette lighter la of this invention can be equipped with a wire winder 8 at its rear part to reel in or out the first power cord 2. Hence, during the charging process, the is first power cord 2 can be extended and adjusted to a proper length depending on the position and/or condition through the operation of this wire winder 8. Even after use, the wire winder 8 can be reeled in to have an easy and convenient collection, and to provide a minimized portable charger structure, therefore.

To sum up, the charger for vehicle use of the current invention can effectively and practically improve the drawbacks of the prior charging structure used inside a vehicle. Also, it provides a better charging solution for almost every kind of portable electronic device 7. Furthermore, the present invention can be configured with a minimized structure with an easy-use, a light and convenient portability.

However, the above mentioned description is only some better embodiments of the present invention. And, it should not be limited as the scope of the present invention. Therefore, any equivalent change or revision based on the idea and/or the description of the current invention shall all be included in this invention.

To enable a better understanding of the said objectives and the technological methods of the invention herein, the brief description of the drawings below are listed as a reference.

What is claimed is:

1. An improved charger for vehicle use, comprising:
a plug of cigarette lighter;
a first power cord, with one end electrically connected to the plug of cigarette lighter;
a transformer, is electrically connected to the other end of the first power cord to operate a DC voltage up-conversion;
a second power cord, with one end electrically connected to the transformer and with an insertion terminal configured at the other end; and
a connection unit, with one end configured with an insertion hole and the other end configured with an alternative insertion part.

2. An improved charger for vehicle use according to claim 1, wherein the second power cord is simplified and the insertion terminal is installed directly to the original output end of the transformer.

3. An improved charger for vehicle use according to claim 1, wherein a wire winder is equipped at the rear part of the plug of cigarette lighter to reel in or out the first power cord.

4. An improved charger for vehicle use according to claim 1, wherein the transformer accepts the DC power input ranging from 10 volts to 30 volts.

5. An improved charger for vehicle use according to claim 1, wherein the transformer operates a DC power voltage-up ranging from 300 volts to 350 volts.

5. An improved charger for vehicle use of claim 1, wherein the insertion part can be configured as a type of two holes or three holes female socket, or a parallel socket.
